(19) United States
(12) Patent Application Publication
(10) Pub. No.: US 2011/0204991 A1
(43) Pub. Date: Aug. 25, 2011

(54) FILTERING CIRCUIT TOPOLOGY

(75) Inventors: Jayanti Jaganatha Rao, Jamestown, NC (US); Chung Liang Lee, Shanghai (CN); Geoffrey Lee Howell, Greensboro, NC (US)

(73) Assignee: RF MICRO DEVICES, INC., Greensboro, NC (US)

(21) Appl. No.: 13/026,716

(22) Filed: Feb. 14, 2011

Related U.S. Application Data
(60) Provisional application No. 61/307,605, filed on Feb. 24, 2010.

(51) Int. Cl. H01P 5/12; H01P 1/10

(52) U.S. Cl. 333/101

(57) ABSTRACT

The exemplary embodiments described provide a low cost architecture for a quad-mode frontend of a communication device. In particular, the exemplary embodiments use diplexers to reduce the complexity of frontend switches and transceivers.

### RELATED APPLICATIONS

This application claims the benefit of provisional patent application No. 61/307,605, filed Feb. 24, 2010, the disclosure of which is incorporated herein by reference in its entirety.

### FIELD OF THE DISCLOSURE

The embodiments described herein relate to using wide frequency diplexing at the input of a multi-filter circuit to reduce the number of switches and low noise amplifiers in a frontend assembly.

### BACKGROUND

Commoditization of cell phones and the growing need for low cost versions for emerging markets require new implementations with reduced costs. This may include low cost mobile devices that can function within different communication systems having different standards of operation.

To this end, there is a need to provide chip sets that can function across multiple standards and regions of the world. One aspect may include a need for circuit topologies for frontend filtering sections that provide low cost solutions for different markets and standards of mobile devices.

### SUMMARY

The exemplary embodiments described in the detailed description provide a low cost architecture for a quad-mode frontend of a communication device. In particular, the exemplary embodiment uses a plurality of diplexers with diplex output filters to interface between a frontend switch and a dual-port transceiver in order to reduce the complexity of the frontend architecture.

An exemplary mobile device frontend may include a switch having a first switch port, a second switch port, and a third switch port. In addition, the mobile device frontend may further include a first diplexer and a second diplexer. The first diplexer may include an input node, a first output node, and a second output node, wherein the input node of the first diplexer is coupled to the first switch port. The second diplexer may include an input node, a first output node, and a second output node, wherein the input node of the second diplexer is coupled to the second switch port. In addition, the mobile device frontend may further include a first band pass filter, a second band pass filter, a third band pass filter, and a fourth band pass filter in communication with a transceiver. The first band pass filter may have an input and an output, wherein the input of the first band pass filter is coupled to the first output node of the second diplexer. The second band pass filter may have an input and an output, wherein the input of the second band pass filter is coupled to the first output node of the first diplexer. The third band pass filter may have an input and an output, wherein the input of the third band pass filter is coupled to the second output node of the first diplexer, and the fourth band pass filter may have an input and an output, wherein the input of the fourth band pass filter is coupled to the second output node of the second diplexer. The transceiver may include a first input and a second input, wherein the first input of the transceiver is in communication with the output of the first band pass filter and the output of the second band pass filter, and wherein the second input of the transceiver is in communication with the output of the third band pass filter and the output of the fourth band pass filter.

Another exemplary embodiment of a mobile device frontend includes a switch, a first diplexer, and a second diplexer. The switch may include a first switch port, a second switch port, and an antenna port coupled to an antenna. The first diplexer may have an input node, a first output node, and a second output node, wherein the input node of the first diplexer is coupled to the first switch port. The second diplexer may have an input node, a first output node, and a second output node, wherein the input node of the second diplexer is coupled to the second switch port. In addition, the mobile device frontend may further include a first band pass filter, a second band pass filter, a third band pass filter, and a fourth band pass filter. The first band pass filter may have an input and an output, wherein the input of the first band pass filter is coupled to the first output node of the first diplexer. The second band pass filter may have an input and an output, wherein the input of the second band pass filter is coupled to the first output node of the second diplexer. The third band pass filter may have an input and an output, wherein the input of the third band pass filter is coupled to the second output node of the second diplexer. The fourth band pass filter may have an input and an output, wherein the input of the fourth band pass filter is coupled to the second output node of the first diplexer. In addition, the output of the first band pass filter may be operably coupled to the output of the second band pass filter to form a first filter output and the output of the third band pass filter may be operably coupled to the output of the fourth band pass filter to form a second filter output.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure, and together with the description serve to explain the principles of the disclosure.

FIG. 1 depicts a frontend section of a quad-band global system for a mobile communication (GSM) radio having a single-pole six-throw switch connected to a quad-port transceiver.

FIG. 2 depicts a frontend section of a quad-band GSM radio having a single-pole quad-throw switch connected to an ultra low cost dual-port transceiver.

FIG. 3 depicts an embodiment of the frontend section of the quad-band GSM radio of FIG. 2.

FIG. 4 depicts an alternate embodiment of the frontend section of the quad-band GSM radio of FIG. 2.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

The exemplary embodiments described hereinafter provide a low cost architecture for a quad-band frontend of a communication device. In particular, the exemplary embodiments use a plurality of diplexers in conjunction with diplexed output filters to interface between a frontend switch and a dual-port transceiver in order to reduce the complexity of the frontend architecture.

An exemplary mobile device frontend may include a switch having an input node, a first switch port, and a second switch port. In addition, the mobile device frontend may further include a first diplexer and a second diplexer. The first diplexer may include an input node, a first output node, and a second output node, wherein the input node of the first diplexer is coupled to the first switch port. The second diplexer may include an input node, a first output node, and a second output node, wherein the input node of the second diplexer is coupled to the second switch port. In addition, the mobile device frontend may further include a first band pass filter, a second band pass filter, a third band pass filter, and a fourth band pass filter in communication with a transceiver. The first band pass filter may have an input and an output, wherein the input of the first band pass filter is coupled to the first output node of the second diplexer. The second band pass filter may have an input and an output, wherein the input of the second band pass filter is coupled to the first output node of the first diplexer. The third band pass filter may have an input and an output, wherein the input of the third band pass filter is coupled to the second output node of the first diplexer, and the fourth band pass filter may have an input and an output, wherein the input of the fourth band pass filter is coupled to the second output node of the second diplexer. The transceiver may include a first input and a second input, wherein the first input of the transceiver is in communication with the output of the first band pass filter and the output of the second band pass filter, and wherein the second input of the transceiver is in communication with the output of the third band pass filter and the output of the fourth band pass filter.

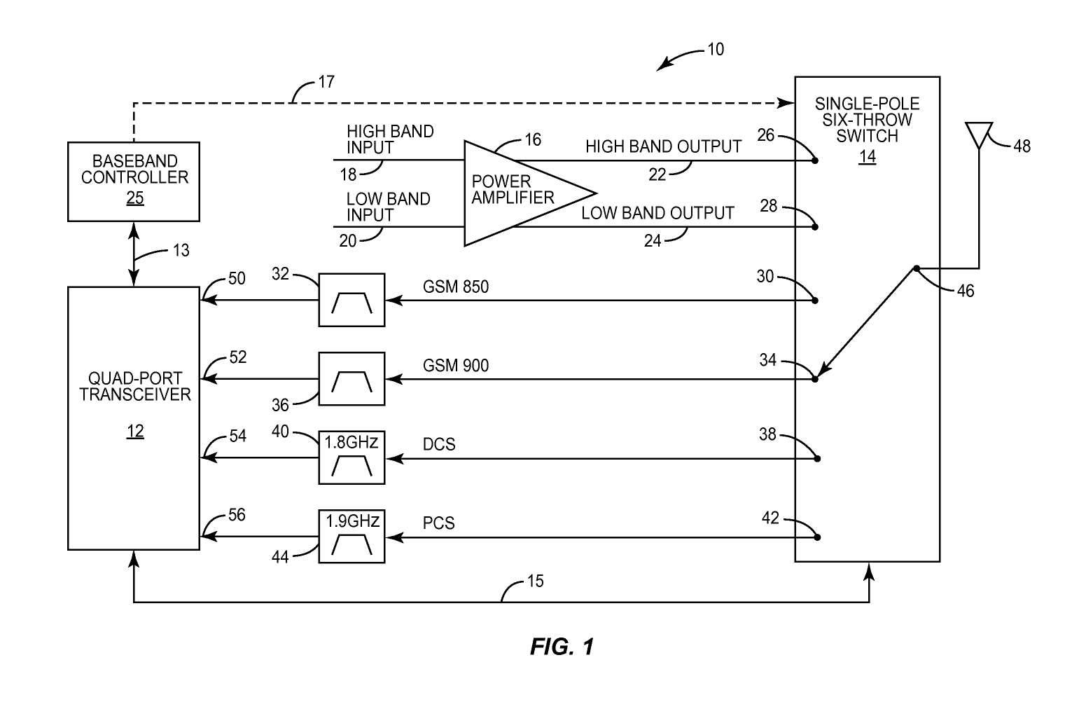

FIG. 1 depicts a frontend section of a quad-band global system for a mobile communication radio 10 including a quad-port transceiver 12 and a single-pole six-throw switch 14. The GSM includes an open, digital cellular technology used for transmitting mobile voice and data services. The mobile communication radio 10 further includes a power amplifier 16 having a high band input 18, a low band input 20, a high band output 22, a low band output 24, and a baseband controller 25.

The baseband controller 25 may be coupled to the quad-port transceiver 12 by a first control signal bus 13. The quad-port transceiver 12 may include a control signal bus 15 coupled to the single-pole six-throw switch 14. Alternatively, the baseband controller 25 may further include a second control signal 17 coupled to the single-pole six-throw switch 14. Accordingly, the control signals to change the state of the single-pole six-throw switch 14 may be generated from the quad-port transceiver 12 acting in concert with the baseband controller 25. The control signals govern the single-pole six-throw switch 14 based upon the operational mode of the mobile communication radio 10. Alternatively, the baseband controller 25 may configure the quad-port transceiver 12 of the mobile communication radio 10 to operate in a GSM900/DCS mode.

As a non-limiting example, the baseband controller 25 may configure the quad-port transceiver 12 of the mobile communication radio 10 to operate in a GSM850/PCS mode. In response to being configured in the GSM850/PCS mode, the quad-port transceiver 12 selectively processes the GSM850 input signal from a first band pass filter 32 and the PCS input signal from a fourth band pass filter 44. As an alternative example, the baseband controller 25 may configure the quad-port transceiver 12 of the mobile communication radio 10 to operate in the GSM900/DCS mode. In response to being configured in the GMS900/DCS mode, the quad-port transceiver 12 may selectively process the GSM900 input signal from the second band pass filter 36 and the DCS input signal from a third band pass filter 40.

The single-pole six-throw switch 14 may include a first port 26 coupled to the high band output 22 of the power amplifier 16 and a second port 28 coupled to the low band output 24 of the power amplifier 16. The single-pole six-throw switch 14 may further include a third port 30 coupled to a first band pass filter 32, a fourth port 34 coupled to a second band pass filter 36, a fifth port 38 coupled to a third band pass filter 40, and a sixth port 42 coupled to a fourth band pass filter 44. An antenna port 46 of the single-pole six-throw switch 14 may be coupled to an antenna 48.

The first band pass filter 32 is configured to have a band pass compatible with the GSM850 band, which has a receive band pass frequency range of 869 megahertz (MHz)-894 MHz (25 MHz bandwidth). The second band pass filter 36 is configured to have a band pass compatible with the GSM900 band, which has a receive band pass frequency range of 925 MHz-960 MHz (35 MHz bandwidth).

The third band pass filter 40 is configured to have a band pass compatible with the GSM1800, which has a receive band pass frequency range of 1805 MHz-1880 MHz (75 MHz bandwidth). The GSM1800 band may also be referred to as the digital cellular service (DCS).

The fourth band pass filter 44 is configured to have a band pass compatible with the GSM1900, which has a receive band pass frequency range of 1930 MHz-1990 MHz (60 MHz bandwidth). The GSM1900 band may also be referred to as the personal communications service (PCS).

The output of the first band pass filter 32 is coupled to a first input 50 of the quad-port transceiver 12. The output of the second band pass filter 36 is coupled to a second input 52 of the quad-port transceiver 12. The output of the third band pass filter 40 is coupled to a third input 54 of the quad-port transceiver 12. The output of the fourth band pass filter 44 is coupled to a fourth input 56 of the quad-port transceiver 12. The first band pass filter 32, the second band pass filter 36, the third band pass filter 40, and the fourth band pass filter 44 may each include one or more surface acoustic wave (SAW) devices, bulk acoustic wave (BAW) devices, micro-electro-mechanical-systems (MEMS) devices, or ceramic filters.

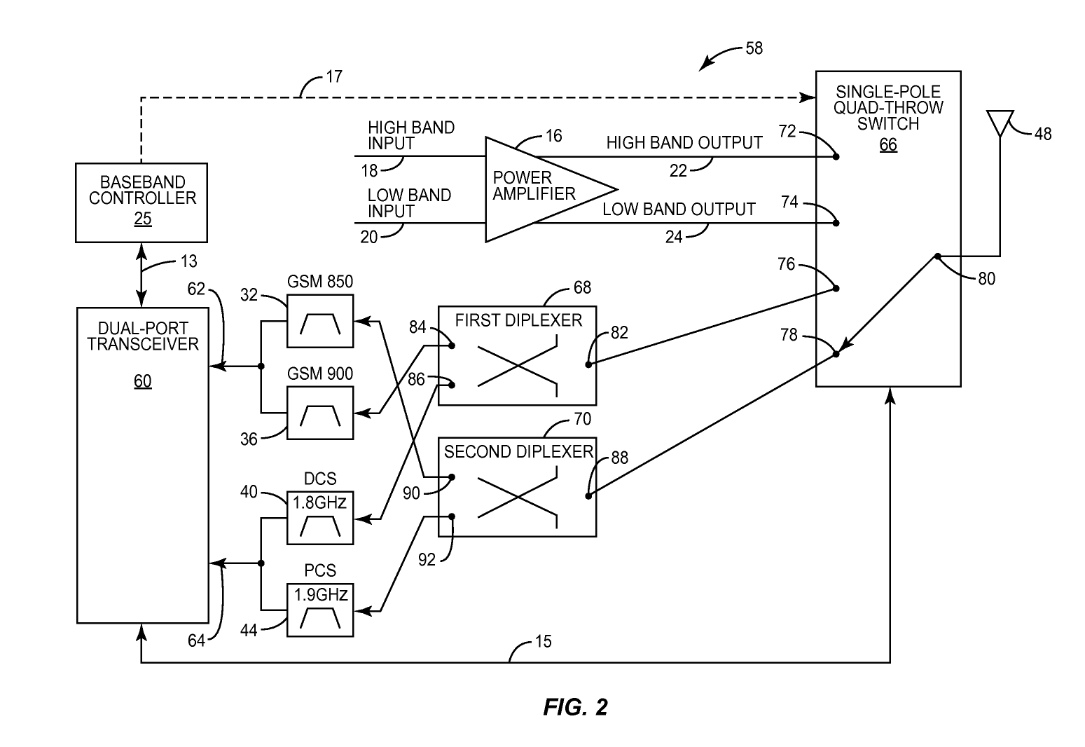

FIG. 2 depicts a frontend section of a quad-band GSM radio 58 connected to an ultra low cost (ULC) dual-port transceiver 60 with a first receiver input 62 and a second receiver input 64. In contrast to the mobile communication radio 10 of FIG. 1, the first receiver input 62 of the dual-port transceiver 60 is in communication with the output of the first band pass filter 32 and the output of the second band pass filter 36. The second receiver input 64 of the dual-port transceiver 60 is in communication with the output of the third band pass filter 40 and the output of the fourth band pass filter 44.

The baseband controller 25 may be coupled to the dual-port transceiver 60 by a first control signal bus 13. The dual-port transceiver 60 may include a control signal bus 15 coupled to the single-pole quad-throw switch 66. Alternatively, the baseband controller 25 may further include a second control signal bus 17 coupled to the single-pole quad throw switch 66. The control signal bus 13 and the second control signal bus 17 may control the switching of the single-pole quad-throw switch 66. The baseband controller 25 may be configured to program the dual-port transceiver 60 to process a signal based upon the operational mode of the mobile communication radio 58.

As a non-limiting example, when the mobile communication radio 58 is configured to operate in a GSM850/PCS system, the baseband controller 25 may configure the dual-port transceiver 60 to process the GSM850 signal provided by the first band pass filter 32 and the PCS input signal provided by the fourth band pass filter 44. Alternatively, the baseband controller 25 may configure the mobile communication radio 58 to operate in the GSM900/DCS mode. In response to operating in the GSM900/DCS mode, the dual-port transceiver 60 may selectively process the GSM900 input signal from the second band pass filter 36 and the DCS input signal from the third band pass filter 40.

The output of the first band pass filter 32 may be coupled to the output of the second band pass filter 36 by a line delay, phase shifting filter, or similar techniques. Likewise, the output of the third band pass filter 40 and the output of the fourth band pass filter 44 may be coupled by a line delay, phase shifting filter, or similar techniques.

Unlike the mobile communication radio of FIG. 1, the quad-band GSM radio 58 includes a single-pole quad-throw switch 66, a first diplexer 68, and a second diplexer 70. The single-pole quad-throw switch 66 includes a first port 72 coupled to the high band output 22 of the power amplifier 16, and a second port 74 coupled to the low band output 24 of the power amplifier 16. The single-pole quad-throw switch 66 may further include a third port 76, a fourth port 78, and a fifth port 80. The fifth port 80 of the single-pole quad-throw switch 66 may be coupled to the antenna 48.

The first diplexer 68 may include an input node 82 coupled to the third port 76 of the single-pole quad-throw switch 66. The first diplexer 68 may further include a first output node 84 coupled to the input of the second band pass filter 36 and a second output node 86 coupled to the input of the third band pass filter 40.

The second diplexer 70 may include an input node 88 coupled to the fourth port 78 of the single-pole quad-throw switch 66. The second diplexer 70 may further include a first output node 90 coupled to the input of the first band pass filter 32 and a second output node 92 coupled to the input of the fourth band pass filter 44.

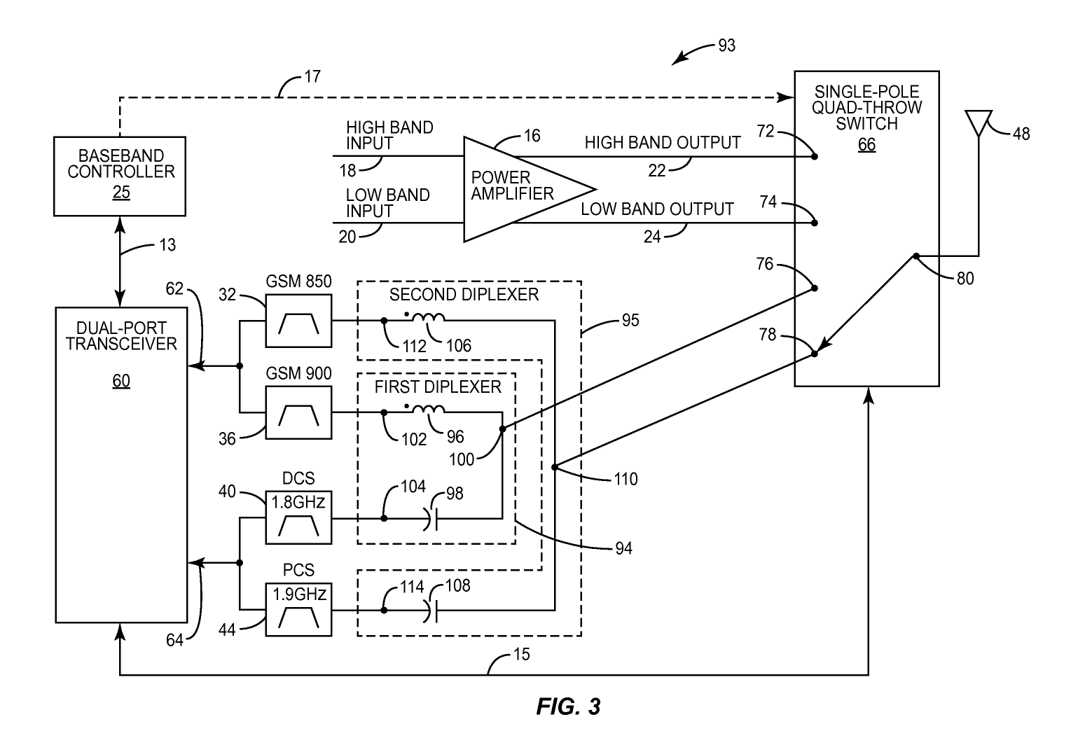

FIG. 3 depicts an embodiment of the quad-band GSM radio 58 of FIG. 2 as a quad-band GSM radio 93 having a first diplexer 94 and a second diplexer 95. As depicted in FIG. 3, the first diplexer 94 and the second diplexer 95 interconnect with the first band pass filter 32, the second band pass filter 36, the third band pass filter 40, and the fourth band pass filter 44 similar to the interconnections of the first diplexer 68 and second diplexer 70 of FIG. 2. Likewise, as discussed above with respect to FIG. 2, the baseband controller 25 may be coupled to the dual-port transceiver 60 via the first control signal bus 13. The baseband controller 25 may also couple to the single-pole quad-throw switch 66 via the second control signal bus 17.

The first diplexer 94 includes an inductor 96 and a capacitor 98 coupled together to form a first input node 100. The opposing end of the inductor 96 forms a first output node 102 of the first diplexer 94. The opposing end of the capacitor 98 forms a second output node 104 of the first diplexer 94. The first output node 102 of the first diplexer 94 and the second output node 104 of the first diplexer 94 are respectively coupled to the input of the second band pass filter 36 and the input of the third band pass filter 40.

The second diplexer 95 includes an inductor 106 and a capacitor 108 coupled together to form a second input node 110. The opposing end of the inductor 106 forms a first output node 112 of the second diplexer 95. The opposing end of the capacitor 108 forms a second output node 114 of the second diplexer 95. The first output node 112 of the second diplexer 95 and the second output node 114 of the second diplexer 95 are respectively coupled to the input of the first band pass filter 32 and the input of the fourth band pass filter 44.

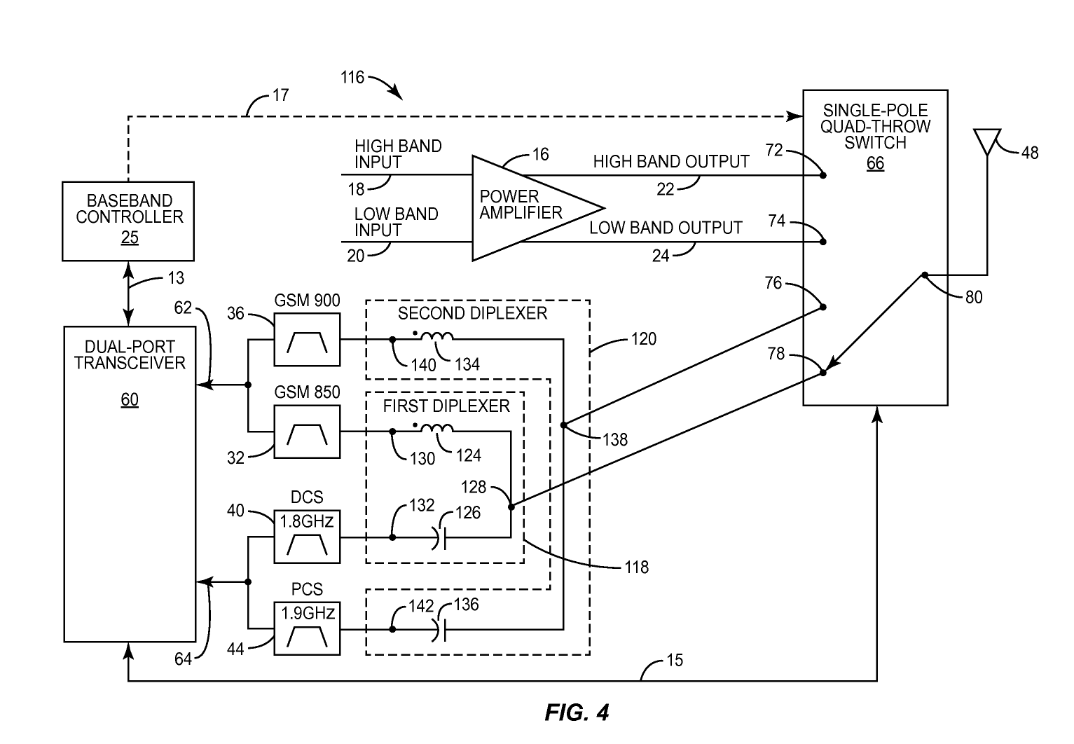

FIG. 4 depicts an alternative embodiment of quad-band GSM radio 93 as a quad-band GSM radio 116. In contrast to the interconnections depicted in FIG. 3, the fourth port 78 of the single-pole quad-throw switch 66 is coupled to a first diplexer 118. In addition, the third port 76 of the single-pole quad-throw switch 66 is coupled to a second diplexer 120. As discussed above with respect to FIGS. 2 and 3, the baseband controller 25 may be coupled to the dual-port transceiver 60 via the first control signal bus 13. The baseband controller 25 may also couple to the single-pole quad-throw switch 66 via the second control signal bus 17.

The first diplexer 118 includes an inductor 124 and a capacitor 126 coupled together to form a first input node 128 of the first diplexer 118. The opposing end of the inductor 124 forms a first output node 130 of the first diplexer 118. The opposing end of the capacitor 126 forms a second output node 132 of the first diplexer 118.

The second diplexer 120 includes an inductor 134 and a capacitor 136 coupled together to form a second input node 138 of the second diplexer 120. The opposing end of the inductor 134 forms a first output node 140 of the second diplexer 120. The opposing end of the capacitor 136 forms a second output node 142 of the second diplexer 120.

The first output node 130 of the first diplexer 118 is coupled to the input of the first band pass filter 32. The second output node 132 of the first diplexer 118 is coupled to the input of the third band pass filter 40. The first output node 140 of the second diplexer 120 is coupled to the input of the second band pass filter 36. The second output node 142 of the second diplexer 120 is coupled to the input of the fourth band pass filter 44.

The various illustrative logical blocks, modules, controllers, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices. As an example, a combination of computing devices may include a combination of a DSP and a microprocessor, a plurality of microprocessors, one or more microprocessors in conjunction with a DSP core, or any other such configuration.

The embodiments disclosed herein may be embodied in hardware and in instructions that are stored in memory, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that a processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. For example, the operational steps illustrated in the flow chart diagrams may be subject to numerous different modifications. Information, data, and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will recognize improvements and modifications to the embodiments of the present disclosure. All such improvements and modifications are considered within the scope of the concepts disclosed herein and the claims that follow.

1. A mobile device frontend comprising:
a switch including a first switch port, a second switch port, and an antenna port;
a first diplexer including an input node, a first output node, and a second output node, wherein the input node of the first diplexer is coupled to the first switch port;
a second diplexer including an input node, a first output node, and a second output node, wherein the input node of the second diplexer is coupled to the second switch port;
a first band pass filter having an input and an output, wherein the input of the first band pass filter is coupled to the first output node of the second diplexer;
a second band pass filter having an input and an output, wherein the input of the second band pass filter is coupled to the first output node of the first diplexer;
a third band pass filter having an input and an output, wherein the input of the third band pass filter is coupled to the second output node of the first diplexer;
a fourth band pass filter having an input and an output, wherein the input of the fourth band pass filter is coupled to the second output node of the second diplexer; and
a transceiver including a first input and a second input, wherein the first input of the transceiver is in communication with the output of the first band pass filter and the output of the second band pass filter, and wherein the second input of the transceiver is in communication with the output of the third band pass filter and the output of the fourth band pass filter.

2. The mobile device frontend of claim 1 wherein the antenna port is coupled to an antenna.

3. The mobile device frontend of claim 1 wherein the switch further includes a third switch port and a fourth switch port, the mobile device frontend further comprising:
a power amplifier including a high band output and a low band output, wherein the high band output is in communication with the third switch port, and wherein the low band output is in communication with the fourth switch port.

4. The mobile device frontend of claim 1 wherein the first band pass filter is configured to pass a global system for mobile communication (GSM) 850 band signal, and wherein the second band pass filter is configured to pass a GSM 900 band signal.

5. The mobile device frontend of claim 4 wherein the third band pass filter is configured to pass a digital cellular service (DCS) signal, and wherein the fourth band pass filter is configured to pass a personal communications service (PCS) signal.

6. A mobile device frontend comprising:
a switch including a first switch port, a second switch port, and an antenna port coupled to an antenna;
a first diplexer including an input node, a first output node, and a second output node, wherein the input node of the first diplexer is coupled to the first switch port;
a second diplexer including an input node, a first output node, and a second output node, wherein the input node of the second diplexer is coupled to the second switch port;
a first band pass filter having an input and an output, wherein the input of the first band pass filter is coupled to the first output node of the first diplexer;
a second band pass filter having an input and an output, wherein the input of the second band pass filter is coupled to the first output node of the second diplexer;
a third band pass filter having an input and an output, wherein the input of the third band pass filter is coupled to the second output node of the second diplexer;
a fourth band pass filter having an input and an output, wherein the input of the fourth band pass filter is coupled to the second output node of the first diplexer;
wherein the output of the first band pass filter is operably coupled to the output of the second band pass filter to form a first filter output; and
wherein the output of the third band pass filter is operably coupled to the output of the fourth band pass filter to form a second filter output.

7. The mobile device frontend of claim 6 wherein the first filter output is configured as a differential output, and wherein the second filter output is configured as a differential output.

8. The mobile device frontend of claim 7 further comprising:
a transceiver including a first differential input and a second differential input, wherein the first differential input of the transceiver is coupled to the first filter output, and wherein the second differential input of the transceiver is coupled to the second filter output.

9. The mobile device frontend of claim 8 wherein the first band pass filter is configured to pass a global system for mobile communication (GSM) 900 band signal, and wherein the second band pass filter is configured to pass a GSM 850 band signal.

10. The mobile device frontend of claim 6 further comprising:
a transceiver including a first input and a second input, wherein the first input of the transceiver is coupled to the first filter output, and wherein the second input of the transceiver is coupled to the second filter output.

11. The mobile device frontend of claim 6 wherein the third band pass filter is configured to pass a digital cellular service (DCS) signal, and wherein the fourth band pass filter is configured to pass a personal communications service (PCS) signal.

12. The mobile device frontend of claim 6 wherein the switch further includes a third switch port and a fourth switch port, the mobile device frontend further comprising:
a power amplifier including a high band output and a low band output, wherein the high band output is in communication with the third switch port, and wherein the low band output is in communication with the fourth switch port.
